(19) United States
(12) Patent Application Publication
(10) Pub. No.: US 2014/0298069 A1
(43) Pub. Date: Oct. 2, 2014

(54) KEY CIRCUIT AND ELECTRONIC DEVICE USING THE SAME

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO. LTD., Shenzhen (CN)

(21) Appl. No.: 14/038,807

(22) Filed: Sep. 27, 2013

(30) Foreign Application Priority Data
Mar. 29, 2013 (CN) 2013101069029

(51) Int. Cl. G06F 1/32

(52) U.S. Cl. CPC G06F 1/3206
USPC 713/340

(57) ABSTRACT

An electronic device includes a first voltage module, a second voltage module, a key circuit, and a processor. The key circuit controls the first voltage module to provide different voltages to the processor based on different operations of user. The processor determines whether the voltage provided by the first module is changed by one pressed key from the key circuit. When the voltage provided by the first module is changed by two pressed keys from the key circuit, the processor does not compares the voltage provided by the first module to standard voltages and does not execute any function.

### BACKGROUND

1. Technical Field

The present disclosure relates to an electronic device having a key circuit.

2. Description of Related Art

An electronic device, such as a DVD player or a computer, includes a number of keys/buttons and a processor for executing different functions corresponding to different pressed keys. Each of the pressed keys generates different voltages. However, when two or more than two keys are simultaneously pressed, the generated voltage may be equal to a voltage corresponding to another key, which results in the processor thinking that a third key is pressed and executing an unexpected function.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment of the disclosure.

FIG. 2 is a circuit diagram of the electronic device of FIG. 1 in accordance with one embodiment of the disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

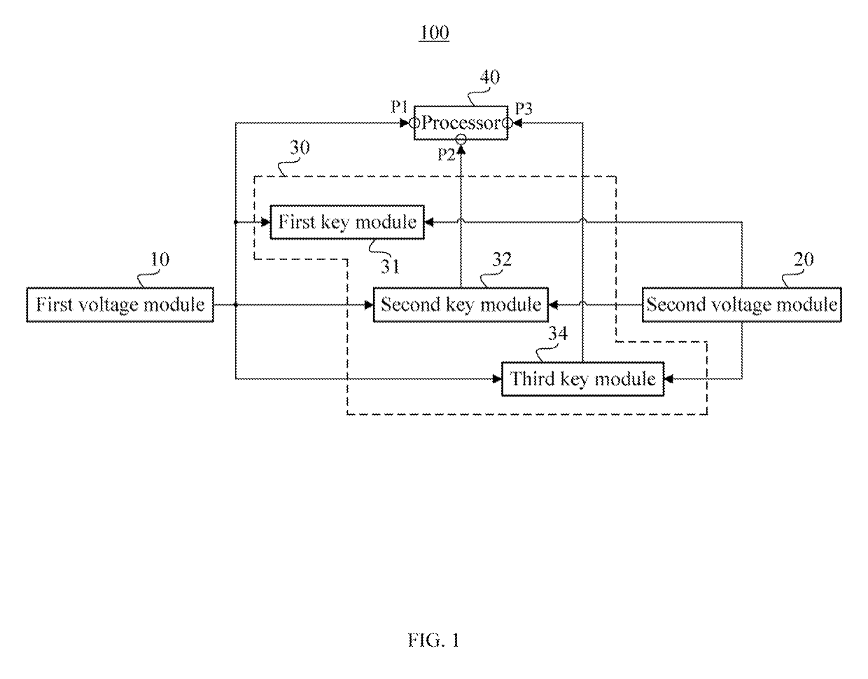

FIG. 1 shows an electronic device 100 according to one embodiment of the present disclosure. The electronic device 100 includes a number of keys. The electronic device 100 is prevented from executing a function when any two or more keys are pressed simultaneously.

The electronic device 100 includes a first voltage module 10, a second voltage module 20, a key circuit 30, and a processor 40.

The first voltage module 10 provides voltage to the processor 40.

The second voltage module 20 is electronically connected to the first voltage module 10 through the key module 30, and provides a second voltage to the key circuit 30. In the embodiment, the second voltage is 0 volts (V).

The key circuit 30 is electronically connected to the first voltage module 10, the second voltage module 20, and the processor module 40. The key circuit 30 controls the first voltage module 10 to output different voltages to the processor 40 when different keys are pressed by a user. The key circuit 30 includes a first key module 31, a second key module 32, and a third key module 34. The first key module 31, the second key module 32, and the third key module 34 are connected in parallel between the first voltage module 10 and the second voltage module 20. The second key module 32 and the third key module 34 are also electronically connected to the processor 40.

The processor 40 detects whether or not the voltage provided by the first voltage module 10 is changed by one of the first, second, or third key modules 31, 32, 34. The processor 40 includes a first port P1, a second port P2, and a third port P3. The first port P1 is electrically connected to the first voltage module 10, the first key module 31, the second key module 32, and the third key module 34. The second port P2 is electrically connected to the second key module 32 and the first voltage module 10. The third port P3 is electrically connected to the third key module 34 and the first voltage module 10. The processor 40 detects voltages of the first port P1, the second port P2, and the third port P3. When only the voltage of the first port P1 is changed, the processor 40 determines that a key from the first key module 31 is pressed. When any two voltages of the first, second, and third ports P1, P2, P3 are changed simultaneously, the processor 40 determines that a key from either of the second key module 32 or third key module 34 is pressed. When the voltages of the first, second, and third ports P1, P2, P3 are changed simultaneously, the processor 40 determines that two or more keys from the first, second, and third key modules 31, 32, 34 are pressed simultaneously. When the voltage of the first port P1 is changed but the voltages of the second port P2 and the third port P3 are not changed, the processor 40 determines that only the first key module 31 is pressed. When the voltages of the first port P1 and the second port P2 are changed simultaneously but the voltage of the third port P3 is not changed, the processor 40 determines that only the second key module 32 is pressed. When the voltages of the first port P1 and the third port P3 are changed simultaneously but the voltage of the second port P2 is not changed, the processor 40 determines that only the third key module 34 is pressed. When the voltages of the first port P1, the second port P2, and the third port P3 are changed simultaneously, the processor 40 determines that two or more keys from the first, second, and third key modules 31, 32, 34 are pressed simultaneously.

When the voltage provided by the first voltage module 10 is changed by one of the first, second, or third key modules 31, 32, 34, the processor 40 further compares the voltage provided by the first voltage module 10 to standard voltages and executes a corresponding function according to the standard voltage matched to the voltage provided by the first voltage module 10.

When any combination of the first, second, and third key modules 31, 32, 34 is being pressed simultaneously, the processor 40 does not compare the voltage provided by the first module 10 to the standard voltages and does not to execute any function.

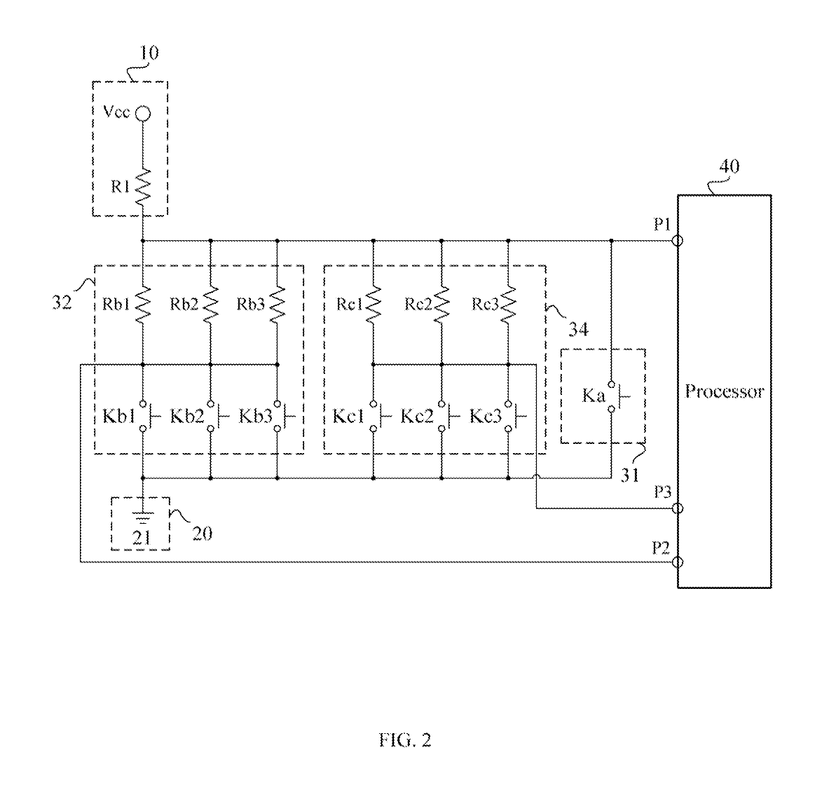

FIG. 2 shows a circuit diagram of the electronic device 100 in accordance with one embodiment. The first voltage module 10 includes a power source Vcc and a first resistor R1. Opposite terminals of the first resistor R1 are connected to the power source Vcc and the key module 30 respectively.

The second voltage module 20 includes a ground port 21.

The first key module 31 includes a key Ka. Opposite terminals of the key Ka are respectively connected to the power source Vcc, through the first resistor R1, and the ground port 21.

In one embodiment, the second key module 32 includes three keys Kb1-Kb3 and three pull-down resistors Rb1-Rb3 corresponding to the three keys Kb1-Kb3. A terminal of each of the keys Kb1-Kb3 is connected to the first resistor R1 through the corresponding pull-down resistors Rb1-Rb3. Opposite terminals of each of the keys Kb1-Kb3 are connected to the ground port 21. The resistances of the keys Kb1-Kb3 are different from each other. A resistance of any combination of the keys Kb1-Kb3 when pressed simultaneously is different from a resistance of the key Kb1, Kb2, or Kb3 when pressed individually.

The third key module 34 includes three keys Kc1-Kc3 and three pull-down resistors Rc1-Rc3 corresponding to the three keys Kc1-Kc3. A terminal of each of the keys Kc1-Kc3 is connected to the first resistor R1 through the corresponding pull-down resistors Rc1-Rc3. Opposite terminals of each of the keys Kc1-Kc3 are connected to the ground port 21. The resistances of the keys Kc1-Kc3 are different from each other. A resistance of any combination of the keys Kc1-Kc3 when pressed simultaneously is different from the resistance of the key Kc1, Kc2, or Kc3 when pressed individually.

The first port P1 is connected to the first resistor R1. The second port P2 is connected between the keys Kb1-Kb3 and the corresponding resistors Rb1-Rb3. The third port P3 is connected between the keys Kc1-Kc3 and the corresponding resistors Rc1-Rc3.

When the key Ka is pressed, the voltage of the first port P1 is changed, and the voltages of the second port P2 and the third port P3 are not changed. The processor 40 compares the detected voltage of the first port P1 to the standard voltages and executes a function corresponding to the standard voltage matched to the detected voltage of the first port P1.

When one of the keys Kb1-Kb3 is pressed, the voltages of the first port P1 and the second port P2 are changed, and the voltage of the third port P3 is not changed. The processor 40 compares the detected voltage of the first port P1 to the standard voltages and executes a function corresponding to the standard voltage matched to the detected voltage of the first port P1. When any combination of the keys Kb1-Kb3 is pressed simultaneously, the detected voltage of the first port P1 does not match any of the standard voltages. Thus the processor 40 does not execute any function.

When one of the keys Kc1-Kc3 is pressed, the voltages of the first port P1 and the third port P3 are changed, and the voltage of the second port P2 is not changed. The processor 40 compares the detected voltage of the first port P1 to the standard voltages and executes the function corresponding to the standard voltage matched to the detected voltage of the first port P1. When any combination of the keys Kc1-Kc3 is pressed simultaneously, the detected voltage of the first port P1 does not match any of the standard voltages. Thus the processor 40 does not execute any function.

When any combination of the key Kb1-Kb3 and the key Kc1-Kc3 are pressed simultaneously, the voltage of the second port P2 and the third port P3 are changed simultaneously. The processor 40 does not compare the detected voltage of the first port P1 to the standard voltages and does not execute any function.

In use, when any combination of the keys are pressed simultaneously, the voltage provided by the first voltage module 10 does not match any of the standard voltages, and the processor 40 does not compare the voltage provided by the first module 10 to the standard voltage. Therefore, misoperation of keys of the electronic device 100 is reduced. Furthermore, separately connecting the second port P2 and the third port P3 to the processor 40 reduces a processing time of the processor 40 when any combination of the keys is pressed simultaneously.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device comprising:
a processor;
a first voltage module providing voltage to the processor;
a second voltage module providing a second voltage; and
a key circuit for controlling first voltage module to provide different voltages to the processor based on different operations of a user;
wherein the key circuit includes a plurality of keys; the processor determines whether the voltage provided by the first module is changed by one pressed key of the key circuit; when the voltage provided by the first module is changed by one pressed key from the key circuit, the processor further compares the voltage provided by the first module to standard voltages and executes a function corresponding to the standard voltage matched to the voltage provided by the first module; when the voltage provided by the first module is changed by two or more pressed keys from the key circuit simultaneously, the processor does not compares the voltage provided by the first module to standard voltages and does not execute any function.

2. The electronic device of claim 1, wherein the processor comprises a first port, a second port, and a third port; the first port connects to the voltage provided by the first voltage module; the second port and the third port connect to the key circuit; the processor detects the voltages of the first port, the second port, and the third port; when only the detected voltage of the first port is changed or the detected voltages of any two of the first port, the second port, and the third port are changed simultaneously, the processor determines that the voltage provided by the first voltage module is changed by one pressed key from the key circuit.

3. The electronic device of claim 2, wherein when detected voltages of the first, second, and third ports are changed simultaneously, the processor determines that two or more keys in the key circuit are pressed simultaneously, and the processor determines that the voltage provided by the first voltage module is changed by two or more pressed keys from the key circuit.

4. The electronic device of claim 2, wherein the key circuit comprises a first key module, a second key module, and a third key module; the first key module, the second key module and the third key module are connected between the first voltage module and the second voltage module in parallel; the second key module connects to the second port, the third key module connects to the third port.

5. The electronic device of claim 1, wherein the key circuit comprises a plurality of keys and a plurality of pull-down resistances corresponding to the keys; a terminal of each of the keys is connected to the first voltage module through the corresponding pull-down resistor, opposite terminals of each of the keys are connected to the second voltage module.

6. The electronic device of claim 5, wherein the resistance of any combination of the resistors when pressed simultaneously is different from the resistance of one of the resistors when pressed individually, and the voltage provided by the first voltage module is different from any of the standard voltages.

7. A key circuit connected to a first voltage module, a second voltage module, and a processor with a plurality of standard voltages; the key circuit controlling the first voltage to output different voltages to the processor by different operations; the key circuit comprising:
a first key module;
a second key module; and
a third key module;
wherein the first, second, third key modules are connected between the first voltage module and the second voltage module in parallel; when the voltage provided by the first module is changed by one of the first, second, third key modules, the processor compares the voltage provided by the first module to standard voltages and executes a function corresponding to the standard voltage matched to the voltage provided by the first module; when the voltage provided by the first module is changed by any combination of the first, second, third key modules, the processor does not compare the voltage provided by the first module to standard voltages and does not execute any function.

8. The key circuit of claim 7, wherein the second and third key modules respectively comprises a plurality of keys and a plurality of pull-down resistors corresponding to the plurality of keys; a terminal of each of the keys is connected to the first voltage module through the corresponding pull-down resistor, opposite terminal of each of the keys is connected to the second voltage module.

9. The key circuit of claim 8, wherein the resistances of the pull-down resistors of the second key module and the third key module are different from each other; the resistance of any combination of the pull-down resistors of the second key module and the third key module is different from the resistance of any one of the pull-down resistors in the second key module and the third key module.

10. The key circuit of claim 8, wherein when any combination keys from the first, second, and third key modules are pressed simultaneously, the voltage provided by the first voltage module does not match with any of the standard voltages.
